(19) United States
(12) Patent Application Publication
(10) Pub. No.: US 2025/0013064 A1
(43) Pub. Date: Jan. 9, 2025

(54) EYEPIECE DEVICE AND TESTING DEVICE WITH AN EYEPIECE DEVICE

(71) Applicant: KARL STORZ SE & Co. KG, Tuttlingen (DE)

(72) Inventors: Tim MÜLLER, Rietheim-Weilheim (DE); Juliane RIEBLE, Tuttlingen (DE); Alicia RIEPLE, Tuttlingen (DE)

(21) Appl. No.: 18/763,424

(22) Filed: Jul. 3, 2024

(30) Foreign Application Priority Data
Jul. 6, 2023 (DE) 10 2023 118 028.2

(51) Int. Cl. G02B 27/36; G02B 25/00

(52) U.S. Cl. CPC G02B 27/36; G02B 25/001

(57) ABSTRACT

An eyepiece device (10), in particular for a testing device (100), includes a mount (20), a reticle (30), and a reticle mount (40) in which the reticle (30) is enclosed. The reticle mount (40) is mounted in the mount (20) so as to be rotatable about an axis of rotation (50). A common center of gravity (55) of the reticle mount (40) and the reticle (30) is outside the axis of rotation (50).

### CROSS REFERENCE TO RELATED APPLICATIONS

This application claims the benefit of priority under 35 U.S.C. § 119 of German Application DE 10 2023 118 028.2, filed Jul. 6, 2023, the entire contents of which are incorporated herein by reference.

### TECHNICAL FIELD

The invention relates to an eyepiece device which is suitable for use in an optical system, in particular a testing device. Furthermore, the invention relates to a testing device with an eyepiece device. For example, the testing device is used to check imaging devices such as exoscopes or video microscopes, in particular for medical applications.

In particular, the user checks an optical zoom sequence and/or an image orientation of the imaging device by means of the testing devices.

In particular, the optical zoom sequence is checked by a user using the testing device to check whether a center point of a field of view of the imaging device shifts when the zoom is changed. In order to check image erection, a user visually checks the horizontal spread of the images from the imaging device in relation to a horizontal line.

### BACKGROUND

For visual inspection, eyepieces with a reticle are used as an optically effective part of testing devices on the eye side, by means of which the user can align the center point of the field of view of the imaging device or the horizontal spread of the images of the imaging device in relation to a horizontal line with lines on a base plate.

Before each test procedure, the eyepiece must be individually adjusted to the head position of the user and/or, if the testing device has two eyepieces, to the eye-to-eye distance of the user by means of pivoting movements, so that the 3-D effect of the imaging device for the human eye is not lost due to an incorrect distance between the eyepieces.

In known eyepieces, the adjustment of the eyepiece(s) to the user also simultaneously changes the orientation of the reticle of the eyepiece(s), which would result in an incorrect test if the user were to make a visual adjustment. Furthermore, by changing the orientation of the reticle of the eyepiece(s), it may be the case that the alignments of the reticles of the eyepieces in testing devices with two eyepieces no longer match, and thus the user perceives mismatched reference lines of the reticle.

In order to start a test procedure, in known eyepieces, the user must therefore manually adjust the orientation or reorientation of the reticle(s) of eyepiece(s), which is a time-consuming process.

### SUMMARY

Starting from the prior art, the invention is based upon the object of achieving easy handling of an eyepiece device.

The object is achieved according to the invention by eyepiece devices for an optical system, in particular for a testing device, as described herein and according to the invention.

The present invention provides for an eyepiece device for an optical system, in particular for a testing device. The eyepiece device comprises a mount, a reticle, and a reticle mount in which the reticle is enclosed. The reticle mount is mounted in the mount so as to be rotatable about an axis of rotation. In addition, a common center of gravity of the reticle mount and the reticle is outside the axis of rotation.

The features according to the invention make it possible to achieve easy handling of an eyepiece device. In particular, the reticle of the eyepiece device can be aligned in a simplified manner, in particular without any user intervention. In particular, the features according to the invention simplify the alignment of an eyepiece device in an optical system.

Preferably, the optical system may comprise a testing device, in particular a testing device for an imaging device such as an exoscope and/or a video microscope. However, the optical system can also be an endoscope, binoculars, a telescope, or a light microscope.

The eyepiece device may comprise an eyepiece and/or be attached and/or attachable to an eyepiece of the optical system. The eyepiece device can be at least substantially in the form of a cylinder.

An eyepiece is in particular the optically effective part of an optical system on the eye side. An eyepiece can consist of a single lens or a lens system in order to virtually display an intermediate image of an optical image for the human eye of a user.

The mount of the eyepiece device can in particular be inserted into a receptacle of the optical system. The receptacle of the optical system is, for example, in the form of a tube. In particular, the mount of the eyepiece device is inserted into a receptacle of a testing device. The mount can be in the form of a cylinder. Furthermore, the mount can be rotationally symmetrical. For example, the mount has an axial direction and a radial direction.

The reticle is primarily used to provide the user with an optical orientation. The reticle is in particular attached to the side of the eyepiece that faces the eye. Furthermore, the reticle can be attached directly in front of the individual lens or the lens system of the eyepiece. In particular, the reticle is located at the inner focal point of the eyepiece, which allows the reticle to appear sharp to the eye of the user.

The reticle may be a glass plate, in particular an opal glass plate, which has at least one reference line. The at least one reference line can be applied to the glass plate and/or incorporated into the glass plate. Furthermore, the reticle can have a few reference lines or even an entire reticle network formed from reference lines. Preferably, the reference lines of the reticle can be configured as crosshairs and/or form crosshairs.

The at least one reference line can be used to estimate or measure small angles. In particular, the at least one reference line marks the horizon of the optical system. This allows the reticle to be used to estimate and/or measure small angles.

In particular, when using the eyepiece device in the testing device for an imaging device, a visual comparison of the reference lines with lines on a base plate of the testing device can be used to determine whether the imaging device is faulty and/or has a suitable optical calibration and/or adjustment. For example, in the case of exoscopes or video microscopes that are set up for 3-D image acquisition, this can prevent incorrect superimposition of mono images, which could lead to a disturbing and/or incorrectly interpretable 3-D perception for the user.

The reticle mount is used in particular to receive the reticle. The reticle mount can completely encompass the circumference of the reticle, i.e., the reticle can limit the reticle mount in the radial direction. In the axial direction, for example, the reticle is largely not covered by the reticle mount. The reticle mount is made in particular of steel.

The reticle mount and the reticle can in particular be connected to one another in a material-locking manner (with a material-locking connection) in order to form a secure and firm connection between the reticle and the reticle mount.

In order to achieve a long-lasting material-locking connection, in particular by gluing, the reticle mount can be made of steel, and the reticle can be made of opal glass.

The axis of rotation can be formed along the axial direction of the reticle mount and defines in particular the axis about which the reticle mount and the reticle in the mount can rotate, or the axis about which the reticle mount is possibly mounted so as to be rotatable by further elements.

Because the common center of gravity of the reticle mount and the reticle is outside the axis of rotation, the reticle mount and the reticle can align themselves, at least largely consistently, even with a wide variety of alignments or orientations of the eyepiece device. In particular, if one eyepiece device is used for each eye of the user, this can ensure that the reference lines of the reticles of the two eyepiece devices are parallel to one another and/or in alignment with one other.

In order for the reticle mount to rotate smoothly in the mount and for the axis of rotation of the reticle mount to be defined in the mount, the eyepiece device may in particular comprise a rotary bearing. In order to make the rotary bearing low-maintenance and long-lasting, the rotary bearing can be a plain bearing. It is also possible to use ball bearings as rotary bearings, in order to make the rotary bearing particularly smooth.

In order to reduce friction between the reticle mount and the mount, the rotary bearing may comprise a slide ring. This is the case in particular if the rotary bearing is a plain bearing. The slide ring can preferably enclose the reticle mount, or the slide ring can surround the reticle mount in the radial direction of the slide ring. The slide ring can in particular rotate with the reticle mount. However, the slide ring can also be inserted into the mount and be stationary relative to the mount.

Furthermore, the slide ring can in particular comprise a self-lubricating material and/or be formed from a self-lubricating material. The self-lubricating material can be Teflon and/or plastic, in particular a black material/plastic and/or black Teflon. The self-lubricating material can reduce the friction between the slide ring and the mount, and/or the friction between the slide ring and the reticle mount. The use of a black material can avoid disturbing light scattering and/or the presence of components in the field of view that are disturbing to the user.

In order to securely fasten the slide ring in the reticle mount and thus increase the service life of the eyepiece device, the reticle mount can be received in the slide ring in a positive-locking manner (with a positive-locking connection). For example, the reticle mount may comprise a recess in the axial direction into which the slide ring is inserted or fitted.

Furthermore, the reticle mount can be received in the slide ring by means of a material-locking connection, in addition to the positive-locking connection or without an additional positive-locking connection. This allows the slide ring to be connected even more securely to the reticle mount in order to further increase the service life of the eyepiece device.

In particular, the reticle mount may be configured to not be rotationally symmetrical or rotationally asymmetrical. This allows the common center of gravity of the reticle mount and the reticle to be pushed out of the axis of rotation of the reticle mount. This allows the reticle to align itself automatically through gravity.

In order to push the common center of gravity of the reticle mount and the reticle out of the axis of rotation of the reticle mount, the reticle mount can in particular have a radially widened portion. The radially widened portion can be realized, for example, by two, different-sized outer diameters of the reticle mount. In particular, the reticle may have markings, by means of which the reticle mount is aligned at a transition between the two different outer diameters of the reticle, in order to simplify the installation of the reticle in the reticle mount.

The reticle can in particular be designed to be rotationally symmetrical in order to be able to use cost-effective reticle plates and thus reduce the cost of the eyepiece device. In particular, standard components can be used as the reticle.

In order to compensate for the non-rotationally symmetrical shape of the reticle mount and to securely connect the reticle mount to the slide ring in a positive-locking manner, the slide ring can have a radial recess in which the radially widened portion of the reticle mount is received.

In order to push the common center of gravity of the reticle mount and the reticle out of the axis of rotation of the reticle, it is alternatively or additionally possible for the reticle to be non-rotationally symmetrical. In some cases, the reticle mount can be rotationally symmetrical. This allows a slide ring with a simple geometry to be used. Furthermore, this may make it possible for the slide ring to be fixedly connected to the mount.

Furthermore, the reticle mount may have an inhomogeneous density. This allows the reticle mount and/or the reticle to be rotationally symmetrical, and yet the common center of gravity of the reticle mount and the reticle can be pushed out of the axis of rotation of the reticle mount. For example, this makes it possible to dispense with the use of a slide ring for the reticle mount, and/or it is possible for the slide ring to be fixedly connected to the mount.

Furthermore, the reticle mount can be mirror-symmetrical. This makes it easier to align the reticle with respect to the reticle mount.

In particular, the reticle may define a horizon oriented perpendicularly to a radial line extending from a center point of the reticle mount through the common center of gravity of the reticle mount and the reticle. This makes it possible to reliably mark the desired center point of the field of view of the eyepiece device, in particular when the eyepiece device is used in a testing device for an imaging device.

For example, in order to ensure that the reticle mount with the reticle is deflected from the desired position when the eyepiece device is tilted, the eyepiece device can in particular comprise a fixing ring which defines a position of the reticle mount in the axial direction.

Preferably, the fixing ring fixes the reticle mount in the axial direction in the mount, thereby at least largely preventing the reticle mount from shifting in the axial direction with respect to the mount.

Alternatively, the fixing ring can also fix the slide ring in the mount in the axial direction, provided that the slide ring moves with the reticle mount. This can also prevent the reticle mount from shifting in the axial direction with respect to the mount.

In order to reduce the friction between the reticle and the fixing ring or between the slide ring and the fixing ring, the fixing ring can in particular be formed from a self-lubricating material.

For example, the fixing ring can be fixed in position relative to the mount to simplify the installation of the fixing ring. In order to securely fasten the fixing ring to the mount, the fixing ring can be screwed into the mount.

The eyepiece device can in particular be incorporated into a testing device. The eyepiece device ensures that the reticle remains consistently aligned even when the eyepiece is aligned differently. This eliminates the need for time-consuming manual adjustment of the alignment of the reticle to the alignment or orientation of the eyepiece device.

Furthermore, the testing device can comprise a further eyepiece device and a receptacle. The receptacle may be configured to receive the eyepiece device and the further eyepiece device. The receptacle may further be configured to allow adjustment of a distance between the eyepiece device and the further eyepiece device to an eye-to-eye distance of a user. This makes it possible to individually adapt the eyepiece device and the further eyepiece device to the user and to ensure that the 3-D effect of an intermediate image of an optical image is not lost for the human eye due to an incorrect distance between the eyepieces. The eyepiece device according to the invention can further ensure that, by adjusting the distance between the eyepiece device and the further eyepiece device to the eye-to-eye distance of the user, a time-consuming manual adjustment of the reticle is no longer necessary.

The present invention is described below by way of example with reference to the accompanying figures. The drawings, the description, and the claims contain numerous features in combination. A person skilled in the art will also, expediently, consider the features individually and use them in combination as appropriate in the context of the claims.

If there is more than one example of a particular object, only one of them may be provided with a reference sign in the figures and in the description. The description of this example can be transferred accordingly to the other examples of the object. If objects are named using numerical words, such as first, second, third object, etc., these are used to name and/or assign objects. Accordingly, for example, a first object and a third object may be included, but not a second object. However, a number and/or sequence of objects could also be derived using numerical words.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side view showing an exemplary embodiment of a testing device with an eyepiece device;

FIG. 2 is a sectional view showing an exemplary embodiment of the eyepiece device; and

FIG. 3 is a sectional view along the section axis A-A of the exemplary embodiment shown in FIG. 2.

### DESCRIPTION OF PREFERRED EMBODIMENTS

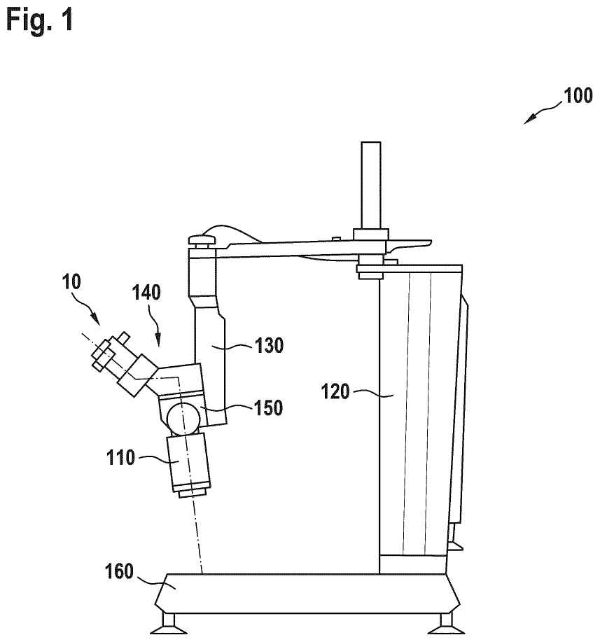

Referring to the drawings, FIG. 1 shows an exemplary embodiment of a testing device 100 with an eyepiece device 10 according to the invention. The testing device 100 comprises a frame 120, a base plate 160, and a pivotable arm 130.

The frame 120 is attached to the base plate 160 or placed on the base plate 160. The pivotable arm 130 is attached to the frame 120.

An imaging device 110, in particular a video microscope, is attached to the pivotable arm 130 via a fastening means 150, in particular a dovetail. This is purely an example; it could be any imaging device. The video microscope 110 can be used as an exoscope in the present case.

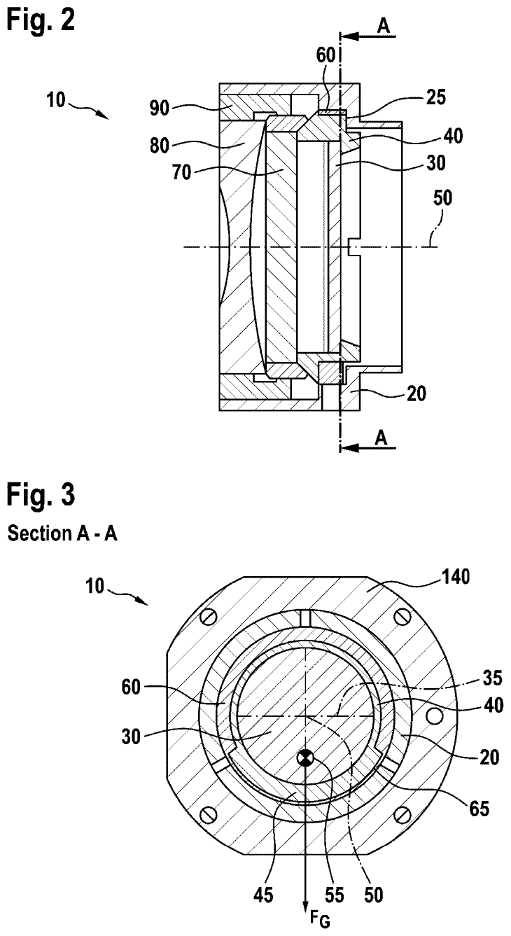

Furthermore, a mount 140 is attached to the pivotable arm 130. The receptacle 140 has two receiving regions, in particular in the form of a tube, into each of which an eyepiece device 10 with a reticle 30 (cf. FIGS. 2 and 3) is inserted. The eyepiece devices 10 can be individually adjusted to the eye-to-eye distance of the user by pivoting movements. The pivoting movements can be generated, for example, in the receptacle 140 by pushing or pivoting the two receiving regions apart. These pivoting movements change not only the eye-to-eye distance, but also the orientation of the eyepiece device 10, received in the receptacle 140, with respect to its respective central axis or longitudinal axis.

Lines (not shown) are applied to the base plate 160. To check the imaging device 110, a user may align reference lines (not shown) on the reticle 30 of the eyepiece devices 10 with the lines on the base plate 160 in order to detect errors in the imaging device 110. In particular, when the imaging device 110 is a video microscope and/or an exoscope, the alignment of the reference lines on the reticle 30 with the lines on the base plate 160 can be used for the user to visually verify an optical zoom sequence and/or to visually verify an image erection of the imaging device 110.

FIG. 2 shows an exemplary embodiment of the eyepiece device 10 according to the invention. The eyepiece device 10 comprises a mount 20 in the form of a rotating body.

A reticle 30 is arranged in the mount 20 and is received in a reticle mount 40. The reticle 30 and the reticle mount 40 can be connected to one another in a material-locking and/or positive-locking manner. Furthermore, the reticle 30 and the reticle mount 40 are mounted in the mount so as to be rotatable about an axis of rotation 50.

The bearing can as shown be a plain bearing. For this purpose, the reticle mount can be received in a slide ring 60 which rotates together with the reticle mount 40 and reticle 30 with respect to the mount 20.

A lens 80 or a lens system (not shown) can be arranged behind the fixing ring 70. The lens 80 can be received in a lens mount 90.

The position of the reticle mount 40 can be further defined axially by a fixing ring 70 and a bearing seat 25 of the mount 20. The fixing ring 70 can, for example, be screwed into the mount 20 or, as shown, into the lens mount 90. The lens mount 90 can in turn be screwed into the mount 20.

FIG. 3 is a sectional view of the exemplary embodiment of the eyepiece device 10 according to the invention, which is shown in FIG. 2. The sectional view also shows, by way of example, that the mount 20 can, for example, be received in the receptacle 140 of the testing device 100 and/or can be attached to the receptacle 140 of the testing device 100, which is shown in FIG. 1.

The sectional view also shows a plan view of the reticle 30, the reticle mount 40, and the slide ring 60. Reference lines 35 are applied to the reticle 30. The reference lines 35 can also be incorporated into the reticle 30. The reference lines 35 can, as shown, be configured as crosshairs and mark a horizontal direction and a direction perpendicular to the horizontal direction.

The exemplary reticle mount 40 has a radially widened portion 45. The exemplary reticle 30 is rotationally symmetrical.

As a result of the radially widened portion 45, the reticle mount 40 is no longer rotationally symmetrical, but still mirror-symmetrical. Furthermore, as a result of the radially widened portion 45, the common center of gravity of the reticle portion and the reticle 55 shifts out of the rotation axis 50 in the direction of the radially widened portion 45. The common center of gravity of the reticle mount and reticle 55 is shown by way of example for illustrative purposes only.

As a result of the mirror-symmetrical design of the reticle mount, the joint weight force F_{G} of the reticle mount 40 and the reticle 30 acts perpendicularly to the reference line 35 of the reticle 30, which is intended to mark the horizontal direction, and thus ensures that the reference lines 35 on the reticle 30 remain correctly aligned after a shift or after a pivoting of the eyepiece device 10.

The reticle mount 40 has two different outer diameters as a result of the radially widened portion 45. By receiving the reticle mount 45 in the slide ring 60, the different outer diameters of the reticle mount 40 can be compensated for by the slide ring 60. In particular, the slide ring 60 has a radial recess 65 for receiving the radially widened portion 45 of the reticle mount 40. Because the slide ring 60 compensates for the different outer diameters of the reticle mount 40, a smooth, precise bearing, in particular a plain bearing, of the reticle 30 in the mount 20 can be achieved.

In other embodiments, a testing device may comprise only one eyepiece or two eyepieces, and a receptacle to which the one or both eyepieces are attached. For testing, the user can hold the imaging device to be tested in their hand, whereby the reticle always rotates to a suitable orientation as a result of the described design of the eyepiece.

While specific embodiments of the invention have been shown and described in detail to illustrate the application of the principles of the invention, it will be understood that the invention may be embodied otherwise without departing from such principles.

### LIST OF REFERENCE CHARACTERS

10 Eyepiece device
20 Mount
25 Bearing seat
30 Reticle
35 Reference line
40 Reticle mount
45 Radially widened portion
50 Axis of rotation
55 Common center of gravity of the reticle mount and the reticle
60 Slide ring
65 Radial recess
70 Fixing ring
80 Lens
90 Lens mount
100 Testing device
110 Imaging device
120 Frame
130 Pivotable arm
140 Receptacle
150 Fastening means
160 Base plate

What is claimed is:

1. An eyepiece device for an optical system, the eyepiece device comprising:
a mount;
a reticle; and
a reticle mount in which the reticle is enclosed, wherein the reticle mount is mounted in the mount so as to be rotatable about an axis of rotation, and wherein a common center of gravity of the reticle mount and the reticle is outside the axis of rotation.

2. An eyepiece device according to claim 1, further comprising a rotary bearing for the reticle mount, the rotary bearing defining the axis of rotation.

3. An eyepiece device according to claim 2, wherein the rotary bearing comprises a slide ring.

4. An eyepiece device according to claim 3, wherein the slide ring is formed from a self-lubricating material.

5. An eyepiece device according to claim 3, wherein the reticle mount is received in the slide ring with a positive-locking connection and/or a material-locking connection.

6. An eyepiece device according to claim 4, wherein the reticle mount is received in the slide ring with a positive-locking connection and/or a material-locking connection.

7. An eyepiece device according to claim 2, wherein the rotary bearing comprises a plain bearing, which plain bearing defines the axis of rotation.

8. An eyepiece device according to claim 1, wherein the reticle mount is not rotationally symmetrical.

9. An eyepiece device according to claim 8, wherein the reticle mount has a radially widened portion.

10. An eyepiece device according to claim 5, wherein the reticle mount has a radially widened portion, and the slide ring has a radial recess in which the radially widened portion of the reticle mount is received.

11. An eyepiece device according to claim 1, wherein the reticle mount has an inhomogeneous density.

12. An eyepiece device according to claim 1, wherein the reticle defines a horizon oriented perpendicularly to a radial line extending from a center point of the reticle mount through the common center of gravity of the reticle mount and the reticle.

13. An eyepiece device according to claim 1, further comprising a fixing ring which defines a position of the reticle mount in an axial direction.

14. An eyepiece device according to claim 13, wherein the fixing ring is formed from a self-lubricating material.

15. An eyepiece device according to claim 13, wherein the fixing ring is stationary relative to the mount.

16. An eyepiece device according to claim 14, wherein the fixing ring is stationary relative to the mount.

17. A testing device comprising:
an eyepiece device, the eyepiece device comprising:
a mount;
a reticle; and
a reticle mount in which the reticle is enclosed, wherein the reticle mount is mounted in the mount so as to be rotatable about an axis of rotation, and wherein a common center of gravity of the reticle mount and the reticle is outside the axis of rotation.

18. A testing device according to claim 17, further comprising:
a further eyepiece device, the further eyepiece device comprising:
a further eyepiece device mount;
a further eyepiece device reticle; and
a further eyepiece device reticle mount in which the further eyepiece device reticle is enclosed, wherein the further eyepiece device reticle mount is mounted in the further eyepiece device mount so as to be rotatable about a further eyepiece device axis of rotation, and wherein a further eyepiece device common center of gravity of the further eyepiece device reticle mount and the further eyepiece device reticle is outside the further eyepiece device axis of rotation; and
a receptacle adapted to receive the eyepiece device and the further eyepiece device, wherein the receptacle is configured for adjustment of a distance between the eyepiece device and the further eyepiece device to an eye-to-eye distance of a user.

19. A testing device according to claim 17, further comprising a rotary bearing for the reticle mount, the rotary bearing defining the axis of rotation.

20. A testing device according to claim 17, wherein the reticle mount is not rotationally symmetrical and/or the reticle mount has an inhomogeneous density.
